(19) United States
(12) Patent Application Publication
(10) Pub. No.: US 2004/0205652 A1
(43) Pub. Date: Oct. 14, 2004

(54) System and method for producing business cards

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/007,829

(22) Filed: Nov. 5, 2001

(51) Int. Cl. G06F 15/00

(52) U.S. Cl. 715/530; 715/515

(57) ABSTRACT

The present disclosure relates to a system and method for producing business cards. In some embodiments, the system and method pertain to receiving personal information to be provided on the business card, storing the personal information as at least one graphic in a personal imaging repository, receiving selection of an arrangement of the personal information on the business card, and storing the arrangement as a composition in the personal imaging repository, wherein the personal imaging repository is accessed via an imaging extension.

### FIELD OF THE INVENTION

The present disclosure relates to a system and method for producing business cards. More particularly, the disclosure relates to a web-based imaging system and method having a distributed architecture with which business cards can be produced.

### BACKGROUND OF THE INVENTION

As computer technology has advanced, the role of computers in our daily lives has expanded, as has the need for various peripheral or supporting devices. One typical peripheral device used with computers is a printer, which generates hard copies of electronic data. The types and capabilities of available printers has similarly been expanding, resulting in a wide variety of printers with a range of printing capabilities, performance, and price.

One significant expansion in the use of computer technology is the networking of computers. Networking computers together allows the computers to communicate with one another as well as with other devices, such as printers. As computer networks, such as the Internet, continue to develop, there is increasing demand for additional and improved functionalities that draw upon and exploit the full computing potential of computer networks.

### SUMMARY OF THE INVENTION

The present disclosure relates to a system and method for producing business cards. In some embodiments, the system and method pertain to receiving personal information to be provided on the business card, storing the personal information as at least one graphic in a personal imaging repository, receiving selection of an arrangement of the personal information on the business card, and storing the arrangement as a composition in the personal imaging repository, wherein the personal imaging repository is accessed via an imaging extension.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic representation of the general operation of the invention.

FIG. 2 is an example distributed system in which the invention can be implemented.

FIG. 3 is a first example web-based imaging system in which the invention can be implemented.

FIG. 4 is a second example web-based imaging system in which the invention can be implemented.

FIG. 5 is a schematic of an imaging client device shown in FIGS. 3 and 4.

FIG. 6 is a flow diagram that provides an overview of the manner in which the inventive system can be used to produce business cards.

FIGS. 7A and 7B provide a flow diagram of an example method for creating business cards.

FIGS. 8A-8C provide example web pages that can be used in the method of FIGS. 7A and 7B.

FIG. 9 is a flow diagram of an example method for printing business cards.

### DETAILED DESCRIPTION

Disclosed is a system and method for producing business cards. Although the term “business cards” is used herein, it will be appreciated that the present disclosure pertains to the production of any electronic and/or printed cards that include imaging data (e.g., text and/or graphics) and therefore is not limited to a “business” context. Generally speaking, the system has a distributed architecture with which a user can maintain imaging data to be added to the business card in a personal imaging repository. In a preferred arrangement, the user accesses a network-based or web-based imaging service that enables the user to access the imaging data in the user's personal imaging repository, as well as arrange the imaging data in a visual representation of the business card. Once the arrangement has been selected, a resultant card representation (i.e., a composition document) can be stored in the user's personal imaging repository and, if desired, one or more hard copy business cards can be generated using a network-based or web-based printing service.

To facilitate description of the inventive system and method, example systems are discussed with reference to the figures. Although these systems are described in detail, it will be appreciated that they are provided for purposes of illustration only and that various modifications are feasible without departing from the inventive concept. After the description of the example systems, examples of operation of the systems are provided to explain the manners in which business cards can be produced.

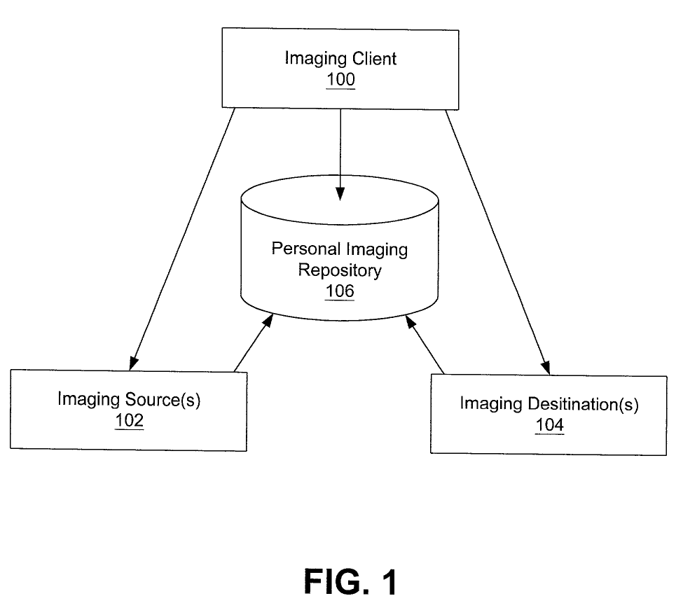

FIG. 1 is a schematic representation of the general operation of the invention. As shown in this figure, an imaging client 100 communicates with one or more imaging sources 102, one or more imaging destinations 104, and a personal imaging repository 106. The imaging source(s) 102 represent any of a wide variety of devices/services that can be accessed by the imaging client 100 and used to select or identify imaging data to be used to create a document.

The personal imaging repository 106 provides image storage facilities that typically are personalized for the individual imaging client 100. The imaging repository 106 can be located in various different places. For example, the repository 106 can be maintained on one or more computing devices associated with the imaging client 100, imaging source(s) 102, or imaging destination(s) 104. Alternatively, the repository 106 can be maintained on a separate computing device (e.g., server) that the imaging client 100, imaging source(s) 102, and imaging destination(s) 104 can access. The imaging data in the imaging repository 106 can be any type of printable data, such as text, graphics, frames of video or animations, pictures, combinations thereof, and so forth.

Once imaging data is stored in the personal imaging repository 106, the imaging client 100 can select data from the repository that is to be communicated to the imaging destination(s) 104 for some form of processing or manipulation. By way of example, the data are communicated to the image destination(s) 104 for printing. Where the imaging destination(s) 104 are adapted for printing, they may comprise any of a wide variety of printing devices that are capable of generating hard copy documents, such as printers, multifunction peripherals (MFPs), plotters, services managing printing devices, and so on.

As will be apparent from the discussions that follow, the above-described manner of operation provides a high degree of personalization to the imaging client 100. Specifically, in that the client's personal information can be accessed and utilized with any participating service (e.g., web site) used by the client, each service can be customized for the user.

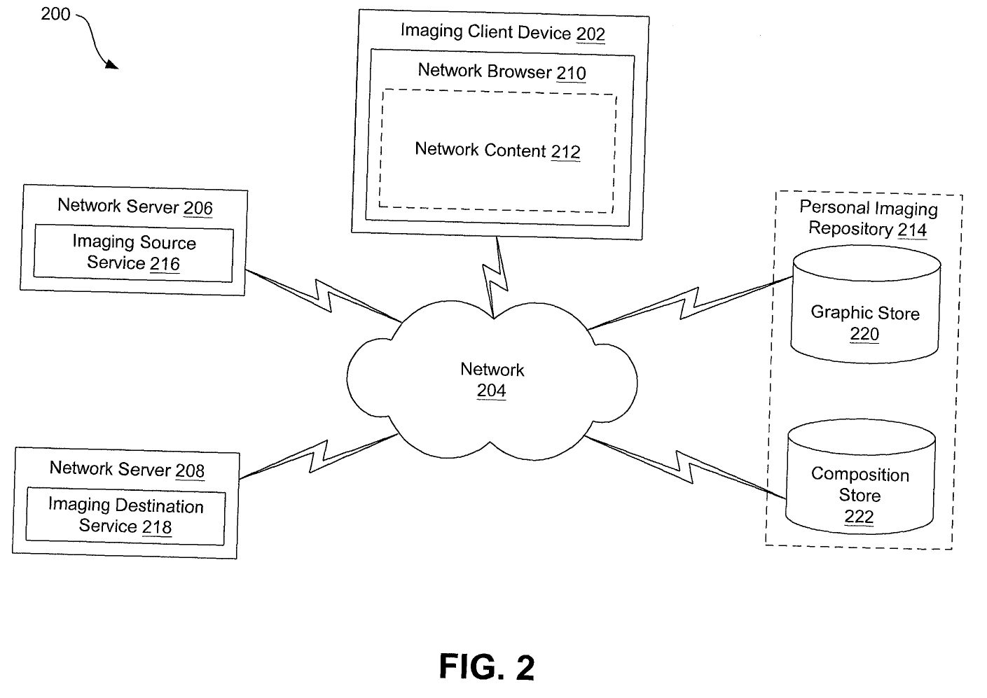

FIG. 2 illustrates an example distributed system 200 in which the invention can be implemented. As indicated in FIG. 2, the system 200 includes an imaging client device 202 that is coupled to a network 204. Through this coupling, the imaging client device 202, and therefore the imaging client (i.e., user), can be placed in communication with one or more network servers, such as servers 206 and 208. The client device 202 and network servers 206 and 208 represent any of a wide variety of conventional wired and/or wireless computing devices, such as desktop computers, portable computers, dedicated server computers, multi-processor computing devices, personal digital assistants (PDAs), mobile telephones, pen-based computers, gaming consoles, and so forth.

The network 204 represents one or more data distribution networks that can be used to communicate data and other information (e.g., control information) between or among various computing devices. Examples for the network 204 include the Internet, a local area network (LAN), a public or private wide area network (WAN), and combinations thereof. The network 204 can further include various different types of networks, including wired and/or wireless portions, employing any of a wide variety of different communications protocols including public and/or proprietary communications protocols.

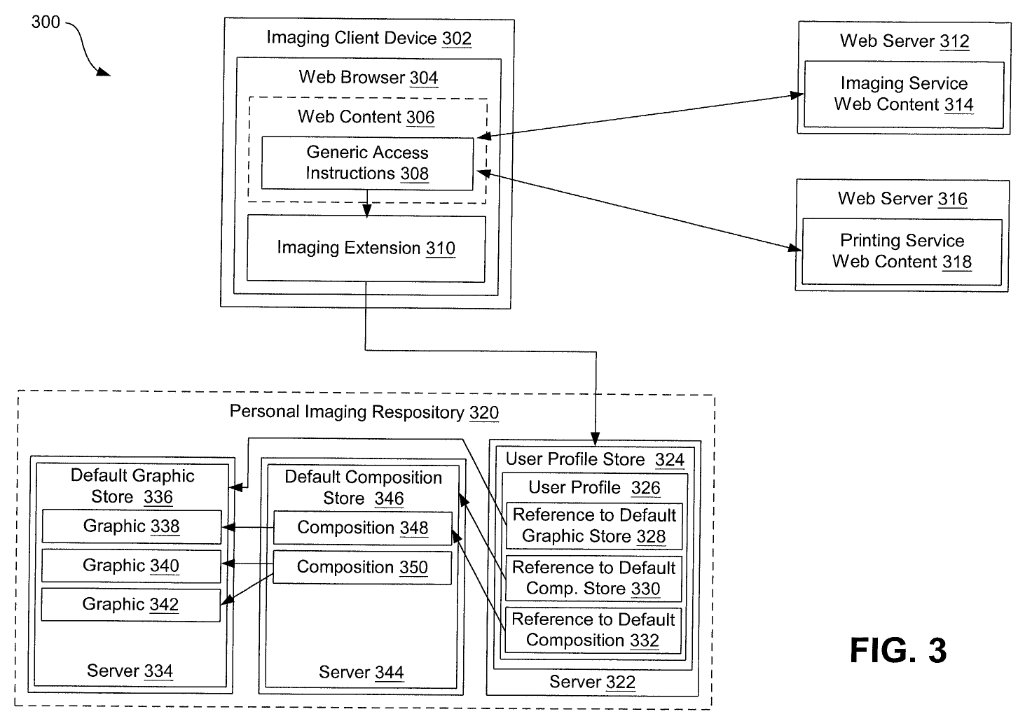

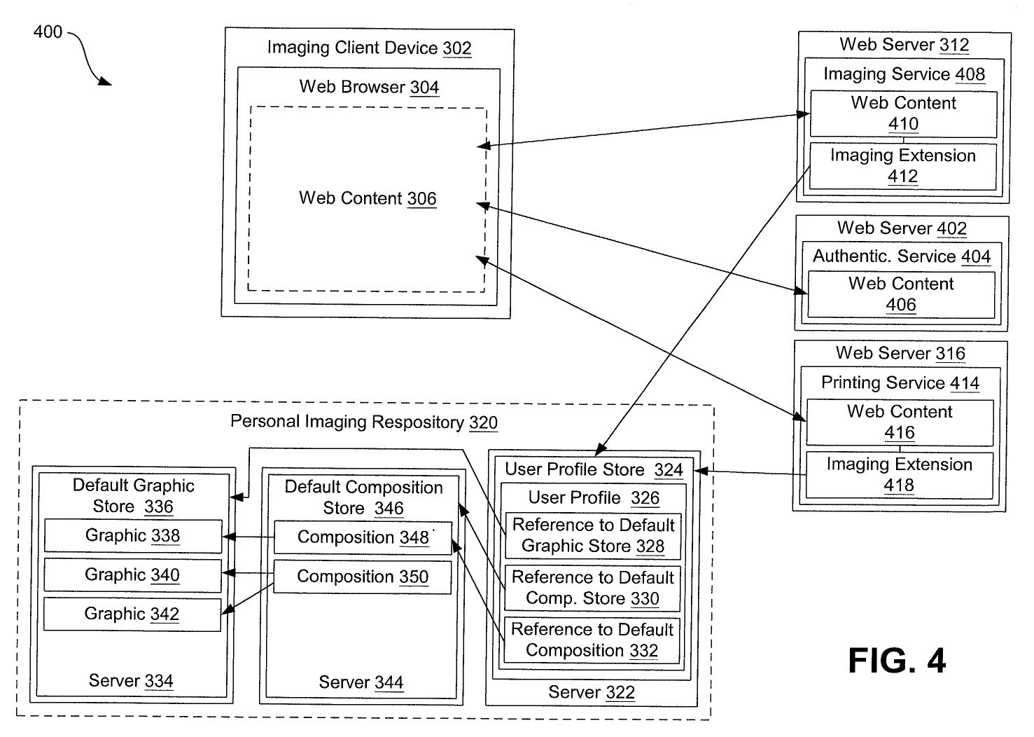

During operation, the user can operate a network browser 210 executing on the imaging client device 202 to interact with imaging services 216, 218 executing on the network servers 206 and 208. As used herein, the term “services” refers to software and/or firmware components that can execute on one or more computing devices and which provide one or more particular functionalities to the imaging client device 202 such as imaging data selection and arrangement, data manipulation, printing, and so forth. As indicated in FIG. 2, the network browser 210 can receive network content 212 from one or more of the network servers 206 and 208. This content 212 typically includes various components such as, for example, text, graphics, and various commands (e.g., hypertext mark-up language (HTML), Java™, JavaScript™, etc.) and/or applications (e.g., Java™ applets). In use, the content 212 can, in some arrangements, facilitate communication with a personal imaging repository 214 so that the servers 206 and 208 can access data stored in the repository. Examples of the ways in which this communication can be facilitated are described below with reference to FIGS. 3 and 4.

The network server 206 executes an imaging source service 216 that, among other things, allows the user to interact with his or her personal imaging repository 214. The imaging source service 216 may actually provide multiple services that can be accessed. In some embodiments, these different services can provide different functionalities. For instance, one service may be responsible for graphic storage and retrieval while another service may be responsible for merging graphics in a single document. By accessing these services with the network browser 210, the user can select or identify imaging data that are to be stored as graphics in a graphic store 220 of the personal imaging repository 214. These graphics can be stored as individual files and generally can compnse any data capable of being represented as a two dimensional graphic. As is discussed below, the individual graphics in store 220 can be used as individual images that can be printed on appropriate print media, or multiple individual graphics can be compiled together as a single image for printing.

Irrespective of whether multiple graphics are to be used, the imaging source service 216 can be used to arrange the graphic(s) on a visual representation of a document to be created. Once the arrangement has been selected, the imaging source service 216 can store the arrangement as a composition (i.e., a composition image) in a composition store 222 of the personal image repository 214. It is to be noted that, although the graphic store 220 and the composition store 222 are illustrated as two separate stores, multiple such stores may exist in the system 200 and one or more graphic stores may be combined with one or more composition stores. Additionally, one or more of these stores 220 and 222 may be implemented on the imaging client device 202, one or more of the servers 206 or 208, or another designated computing device (not shown).

Once the graphics and composition have been selected, the image data can be processed or otherwise manipulated by accessing an imaging destination service 218 that executes on the network server 208. Where one or more hard copy documents are to be generated, this service 218 can comprise a print service with which the document(s) can be printed. In such a scenario, a print request is communicated to the imaging destination service 218 and, upon receipt of the print request, the network server 208 interacts with the graphic store 220 and composition store 222 to retrieve the data needed to complete the print job. Once these data are retrieved, the network server 208 interacts with one or more printing devices (not shown) to which the server is coupled (directly or indirectly) to generate the hard copy document(s).

FIG. 3 illustrates a first example web-based imaging system 300 in which the invention can be implemented. As will be appreciated from the discussion that follows, this system 300 can be described as a client-based implementation in that much of the system functionality is provided by a client device. A similar system is described in detail in U.S. patent application Ser. No. 09/924,058, entitled “A Method, System and Program Product for Multiprofile Operations and Expansive Profile Operation,” by Shell Simpson, Ward Foster, and Kris Livingston and bearing Attorney Docket No. 10007690-1, the disclosure of which is hereby incorporated by reference into the present disclosure.

As indicated in FIG. 3, the system 300 includes an imaging client device 302. The imaging client device 302 comprises a web browser 304 that is adapted to access web content 306 derived from imaging service web content 314 and printing service web content 318 of web servers 312 and 316, respectively. The web content 306, like content 212, typically comprises text, graphics, and various commands. The commands can comprise one or more sets of executable instructions that are downloaded into the browser 304 to perform a service requested by the user. These instructions can be written in any suitable language including, for instance, HTML, Java™, JavaScript™, C-sharp, or other appropriate language. A variety of different functionalities can be served by the executable instructions. For example, the web content 306 normally includes executable instructions for causing target graphics, i.e. graphics provided by an accessed web site, to be displayed to the user.

In the embodiment shown in FIG. 3, the executable instructions are further used to access a personal imaging repository 320. These instructions typically comprise system-wide generic access instructions 308 that call on methods of an imaging extension 310 to access the personal imaging repository 320 and perform various web imaging operations. These instructions 308 are designated as “generic” because they are independent of the configuration of the user's personal imaging repository 320. As is discussed in greater detail below, the generic access instructions 308 can be used to, for example, add a graphic to a default graphic store 336 of the personal imaging repository 320, or add a new composition to a default composition store 346 of the repository.

As is further indicated in FIG. 3, the imaging extension 310 can form part of the browser 304. Although this arrangement is shown in the figure and described herein, the imaging extension 310 can, alternatively, be provided outside of the browser 304, for instance on a different device. Irrespective of its location, however, the imaging extension 310 is configured to respond to the execution of the generic access instructions 308 by generating/mapping to corresponding imaging client specific commands of the user. The imaging extension 310 typically is implemented as one or more application programming instructions (APIs) that, preferably, act as interfaces in accordance with a system-wide standard.

When executed, the generic access instructions 308 cause imaging extension calls (e.g., API calls) to be issued which, in turn, cause the imaging extension 310 (e.g., APIs) to access to the user's personal imaging repository 320. The web content 306 therefore uses the imaging extension 310 as a gateway to access the user's personal imaging repository 320. Generally speaking, the APIs can comprise sets of methods for establishing a destination for redirecting the browser 304 based on some form of received redirection initiation. In such circumstances, the process normally comprises receiving a redirection initiation to redirect the browser 304, retrieving a direct or indirect reference to a destination, and then causing the browser to browse to that destination. It will be recognized that there are many other ways (both in hardware and software) to implement this same functionality.

In some arrangements, the imaging extension 310 is configured to prevent the web content 306 (i.e., the executable instructions from one or more web services), from arbitrarily accessing the user's personal imaging repository 320. This restricted access can be imposed upon the web content 306 using a variety of methods. For example, an imaging extension API can be configured to only accept references from the web content 306 that were previously provided by the imaging extension 310. In such a scenario, the content 306 cannot arbitrarily supply references when calling the imaging extension API. Therefore, in order to access the user's personal imaging repository 320, the web content 306 must first obtain references using the imaging extension API.

The imaging extension 310 can be used to access one or more user profiles 326 that is/are stored in a user profile store 324 of a server 322 of the personal imaging repository 320. By way of example, the imaging extension 310 can be directed to the user profile 326 with a uniform resource locator (URL), pointer, socket, or other backroom detail. In some embodiments, the same user can have multiple user profiles. This may be particularly advantageous when a firewall (not shown) is used in that different graphic stores and composition stores can be used depending on whether the user is inside or outside of the firewall.

The user profile 326 typically includes references to all or a portion of the personal imaging repository 320 for that user profile. For instance, as shown in FIG. 3, the user profile 326 can include a reference 328 to a default graphic store, a reference 330 to a default composition store, and a reference 332 to a default composition. In use, the user profile 326 functions as a service that uses appropriate methods to create, modify, access, and cancel profiles. Accordingly, the imaging extension 310 maps to the appropriate methods (i.e., makes use of the methods) in the user profile 326 to obtain the reference to various repository items such as the default graphic store 336 and the default composition store 346.

Like the user profile store 324, the default graphic store 336 and default composition store 346 can reside on separate servers 334 and 344. It will be understood, however, that one or more of the stores could reside on a single machine, if desired. As indicated in FIG. 3, the default graphic store 336 is used to store various graphics, such as graphics 338, 340 and 342. These graphics can be stored in substantially any format. For example, these formats can comprise PDF, JPEG, PostScript, TIFF, GIF, BMP, etc. In addition, the default graphic store 336 can include one or more APIs. Therefore, in contrast to merely providing for graphic storage, the graphic store 336 can also provide services used to create, retrieve, and/or manipulate graphics. Furthermore, the default graphic store 336 can communicate with the web content of various web services. For example, printing service web content 318 can submit queries to the default graphic store 336 (via the extension 310) about a print job as well as request that one or more graphics be transmitted in a desired arrangement to optimize printing performance.

The default composition store 346 stores various compositions, such as compositions 348 and 350, which can be used to arrange the selected graphics. Like the user profile store 324 and default graphic store 336, the default composition store 346 can also comprise various APIs that can access graphics from the graphic store, manipulate the graphics, etc.

FIG. 4 illustrates a second example web-based imaging system 400 in which the invention can be implemented. As indicated in FIG. 4, the system 400 includes many of the features of the system 300 shown in FIG. 3. Therefore, the system 400 includes an imaging client device 302 that executes a web browser 304 to receive web content 306. The system 400 also includes a personal imaging repository 320 that can, for instance, comprise a user profile store 324, a default graphic store 336, and a default composition store 346. Furthermore, the system 400 includes web servers 312 and 316. Each of these components are generally configured in similar manner as the like-named and numbered features identified in FIG. 3. However, unlike the client-based system 300, the system 400 provides a server-based implementation in which much of the functionality provided by the client device 302 in the system 300 is transferred to another device. By way of example, this other device can comprise a further web server 402, which executes an authentication service 404. As shown in FIG. 4, the authentication service 404 comprises web content 406 (e.g., generated on the fly) that can be downloaded into the user's browser 304.

In addition to the above-noted differences, the servers 312 and 316 are provided with different software in the system 400 to permit alternative modes of operation. By way of example, the web server 312 can execute an imaging service 408, which includes web content 410 and an imaging extension 412. Similarly, the web server 316 can execute a printing service 414 which includes web content 416 and an imaging extension 418. Like the web content 314 and 318 of the system 300, the web content 410 and web content 416 typically comprise text and graphics that can be downloaded into the user's browser 304. Unlike the system 300, however, generic access instructions need not be downloaded into the browser 304 in that the browser does not comprise its own imaging extension. Such an arrangement is advantageous where the client device 302 has limited storage capacity (e.g., for PDAs, mobile telephones). Instead, as identified above, the services 408 and 414 include their own imaging extensions 412 and 418 that can be used to access the user's personal imaging repository 320. By way of example, the content 410 and 416 comprise server-side code including one or more of PHP script, Java™ Servlets, Java™ server pages (JSPs), active server pages (ASPs), etc.

Each of the imaging extensions 412 and 418 typically have configurations that are similar to that of the imaging extension 310. Therefore, the imaging extensions 412 and 418 can comprise one or more APIs that, when executed, access to the user's personal imaging repository 320. Again, the APIs can comprise sets of methods for establishing a destination for redirecting the browser 304 based on some form of received redirection initiation. The APIs can implement, for instance, a URL, pointer, socket, or other backroom detail to facilitate the redirection.

The manner in which the personal imaging repository 320 is accessed by the services in the system 400 will now be discussed with reference to an example scenario. In this example, the user browses to the imaging service 408 using the web browser 304 of the client device 302. Upon reaching the service 408, web content 410 is executed to generate web pages that are downloaded to the web browser 304 (as content 306). Once this occurs, the browser 304 is redirected by the content 306 to the authentication service 404 that resides on the web server 402. Typically, this is accomplished by the web content 410 by generating a hypertext transfer protocol (HTTP) redirect that, when downloaded to the browser 304, causes the browser to redirect to an address (e.g., URL) identified in the header entry. Web content is then downloaded to the web browser 304 and the user is provided with an opportunity to complete an authentication procedure that identifies both the user's identity and the location of the user's personal imaging repository 320. The authentication procedure can, for example, comprise entry of authentication information, such a user name and password, that has been registered with the authentication service 404, for example, in a previous session. This information can be entered in a web page generated by the server 402. In an alternative arrangement, the authentication procedure can comprise the reading of a user identification card which includes storage media (e.g., magnetic strip) that contains the user's authentication information. Persons having ordinary skill in the art will recognize that many other authentication alternatives exist.

Once the authentication procedure is successfully completed by the user, the browser 304 is again redirected, this time back to the imaging service 408. The redirection address (e.g., URL) used to revisit the imaging service 408 contains information that identifies the user and information identifying the user's personal imaging repository 320 (e.g., with a further URL). To avoid continual redirection back and forth, a “cookie” can be stored on the client device 302 that permits the authentication service 404 to validate the user's identity without requiring a further log in. Once this information is possessed by the imaging service 408, the service can, when appropriate, make calls to its imaging extension 412 (e.g., API calls) to command the imaging extension to access the user profile store 324 of the personal imaging repository 320. Through this access, the imaging service 408 can be used by the user to, for instance, select or identify imaging data to be stored as graphics in the default graphic store 336.

When the printing service 414 is accessed, for example through redirection from the imaging service 408 when a “print” button is selected, various content is downloaded to the web browser 306. The printing service 414 can then access the default graphic store 336 and default composition store 346 such that the graphics to be printed can be accessed and their arrangement on the document obtained.

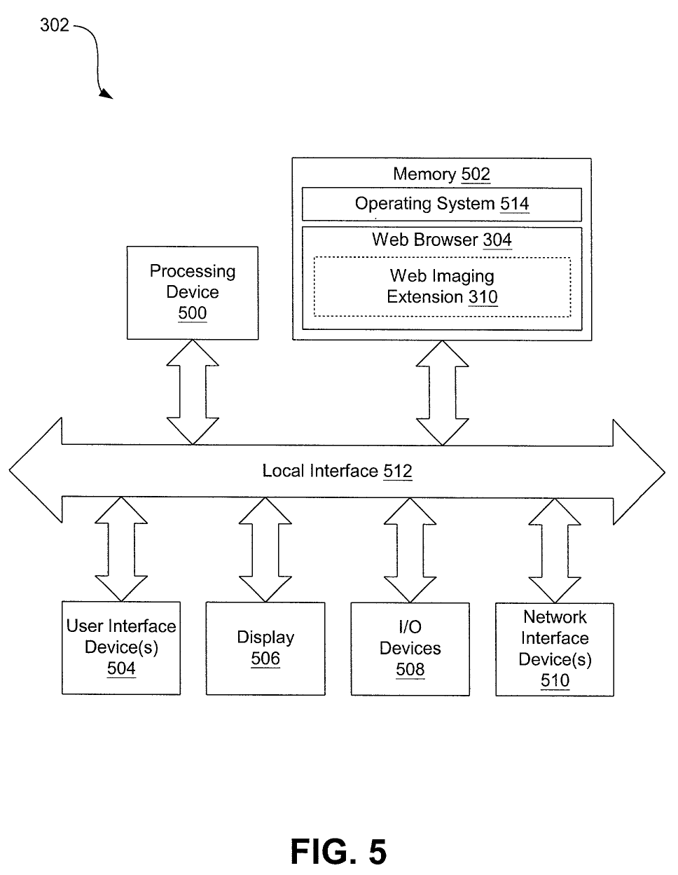

FIG. 5 is a schematic view illustrating an example architecture for the imaging client device 302 identified in FIGS. 3 and 4. As identified above, the client device 302 can be any one of a wide variety of conventional wired and/or wireless computing devices, such as desktop computers, portable computers, dedicated server computers, multi-processor computing devices, cellular telephones, PDAs, handheld or pen-based computers, gaming consoles, and so forth. Irrespective its type, the client device 302 typically comprises a processing device 500, memory 502, one or more user interface devices 504, a display 506, one or more input/output (I/O) devices 508, and one or more networking devices 5 10, each of which is connected to a local interface 512.

The processing device 500 can include any custom made or commercially available processor, a central processing unit (CPU) or an auxiliary processor among several processors associated with the client device 302, a semiconductor based microprocessor (in the form of a microchip), a macroprocessor, one or more application-specific integrated circuits (ASICs), a plurality of suitably configured digital logic gates, and other well known electrical configurations comprising discrete elements both individually and in various combinations to coordinate the overall operation of the client device 302. The memory 502 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 504 comprise those components with which the user can interact with the client device 302. For example, where the client device 302 comprises a personal computer (PC), these components can comprise a keyboard and mouse. Where the client device 302 comprises a handheld device (e.g., PDA, mobile telephone), these components can comprise function keys or buttons, a touch-sensitive screen, a stylus, etc. The display 506 can comprise a computer monitor or plasma screen for a PC or a liquid crystal display (LCD) for a handheld device.

With further reference to FIG. 5, the one or more I/O devices 508 are adapted to facilitate connection of the client device 302 to another device and may therefore include one or more serial, parallel, small computer system interface (SCSI), universal serial bus (USB), IEEE 1394 (e.g., Firewire™), and/or personal area network (PAN) components. The network interface devices 510 comprise the various components used to transmit and/or receive data over a network (e.g., network 204 in FIG. 2). By way of example, the network interface devices 510 include a device that can communicate both inputs and outputs, for instance, a modulator/demodulator (e.g., modem), wireless (e.g., radio frequency (RF)) transceiver, a telephonic interface, a bridge, a router, network card, etc.

The memory 502 normally at least comprises an operating system 514 and a web browser 304. The operating system 514 controls the execution of other software and provides scheduling, input-output control, file and data management, memory management, and communication control and related services. As noted above with reference to FIGS. 3 and 4, the web browser 304 comprises software and/or firmware that is used to access various services over a network (e.g., Internet) and, therefore, download content from various different sources. Where the web browser 304 is configured as indicated in FIG. 3, the browser can comprise an imaging extension 310. However, it will be understood that where the system is arranged as indicated in FIG. 4, the imaging extension 310 need not be provided in the browser 304.

The architecture of the various servers shown in FIGS. 3 and 4 are typically similar to that described above with reference to FIG. 5. Therefore, separate figures are not provided for these servers. Regardless, however, persons having ordinary skill in the art will recognize the various different architectures that could be used for the construction of the servers.

Various software and/or firmware has been described herein. It is to be understood that this software and/or firmware can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, operation of the systems will now be discussed. In the discussions that follow, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

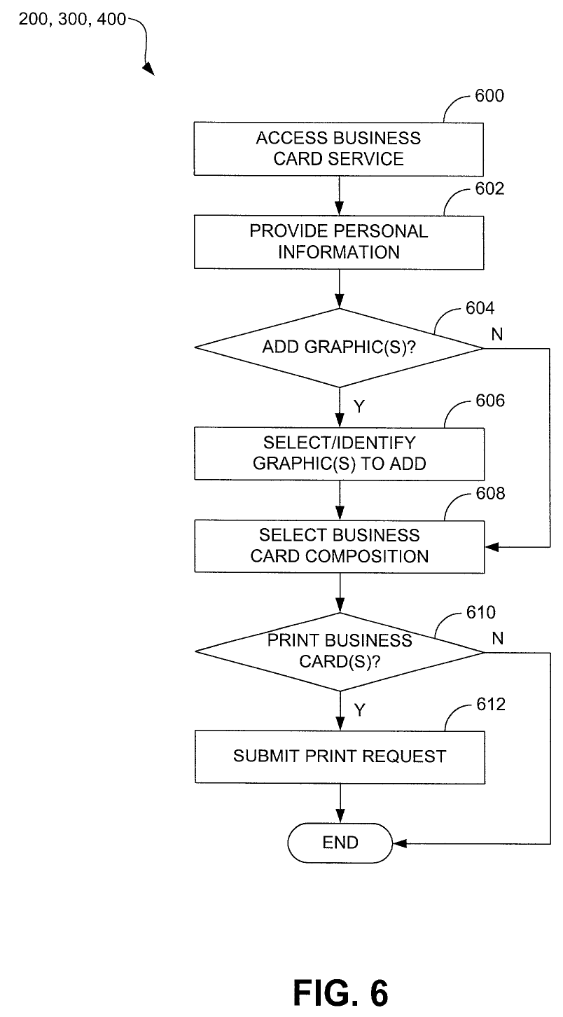

FIG. 6 provides an overview of the manner in which the inventive system, e.g., one or a combination of systems 200, 300, and 400, is used to produce business cards. As indicated in block 600, a business card service is first accessed by the user. Once the service is accessed, the user provides various personal information to the service that will be used to generate the business cards, as indicated in block 604. This personal information comprises the various information that will be provided on the business cards. With reference to decision element 604, it can be determined whether one or more graphics are to be added to the card. If not, flow continues down to block 608 described below. If one or more graphics are to be added to the business card, however, flow continues to block 606 at which the graphics to be added are selected or identified. Once the graphics are selected or identified, the business card composition is selected, as indicated in block 608. As identified above, this composition comprises the arrangement of the information, including one or more graphics, on the business card.

At this point, the content and arrangement of the business card have been selected by the user. Next, with reference to decision element 610, it can be determined whether hard copy business cards are to be generated. If not, flow for the business card production is terminated and the business card information can be stored and/or utilized in electronic form (e.g., to email business cards). If hard copy business cards are desired, however, flow continues to block 612 at which a print request can be submitted.

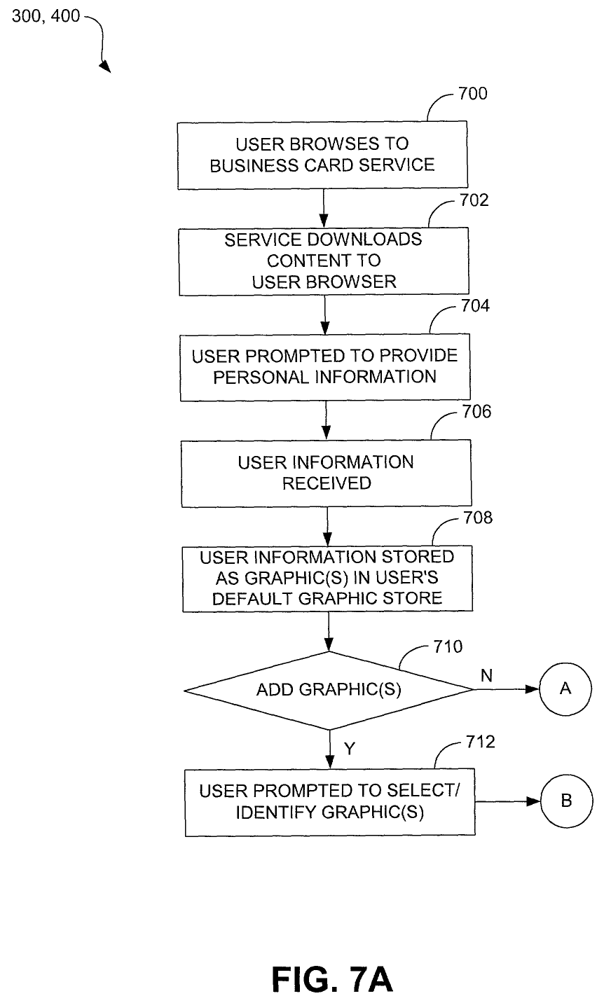

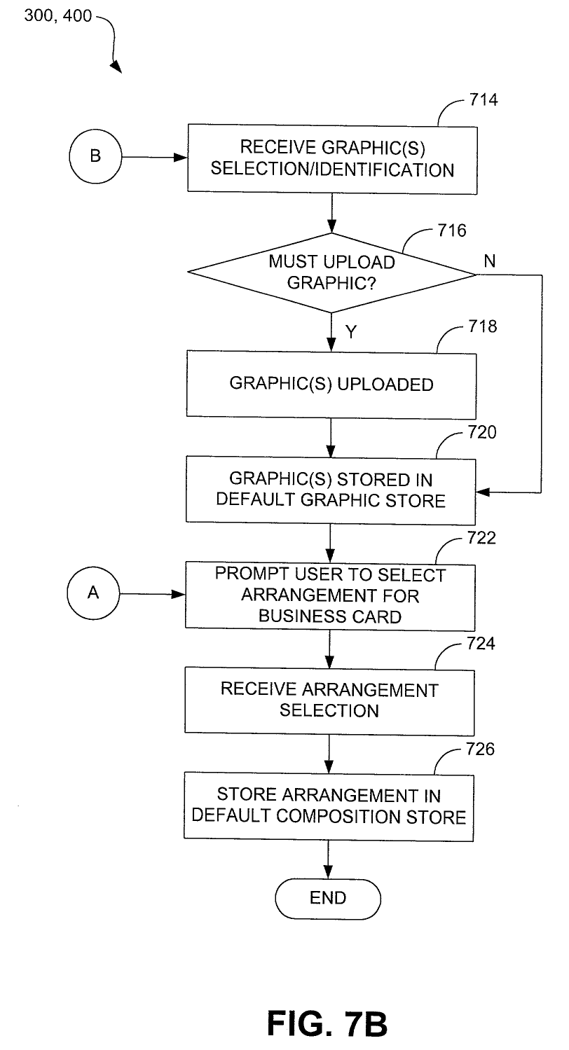

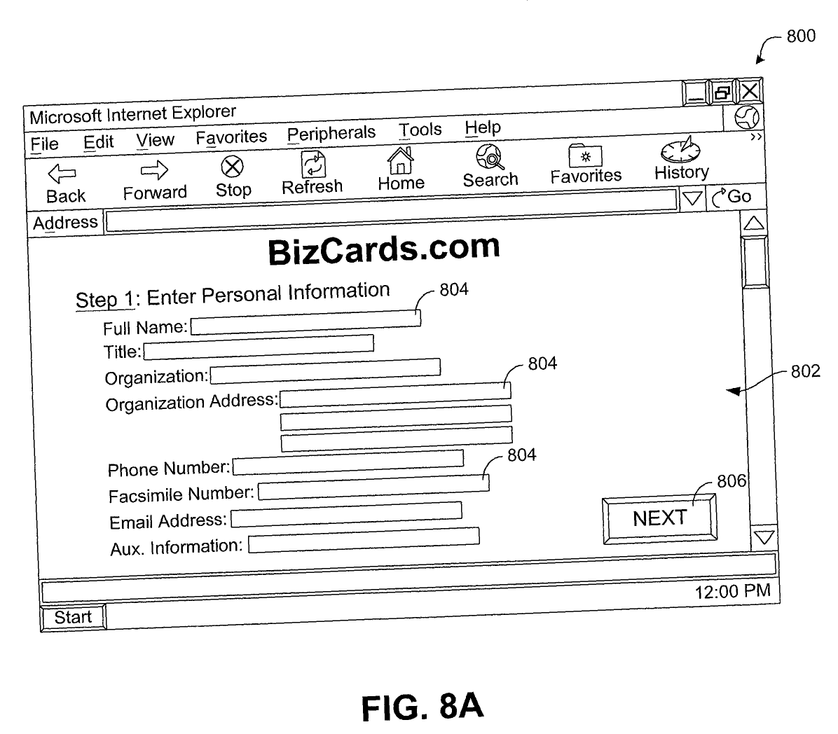

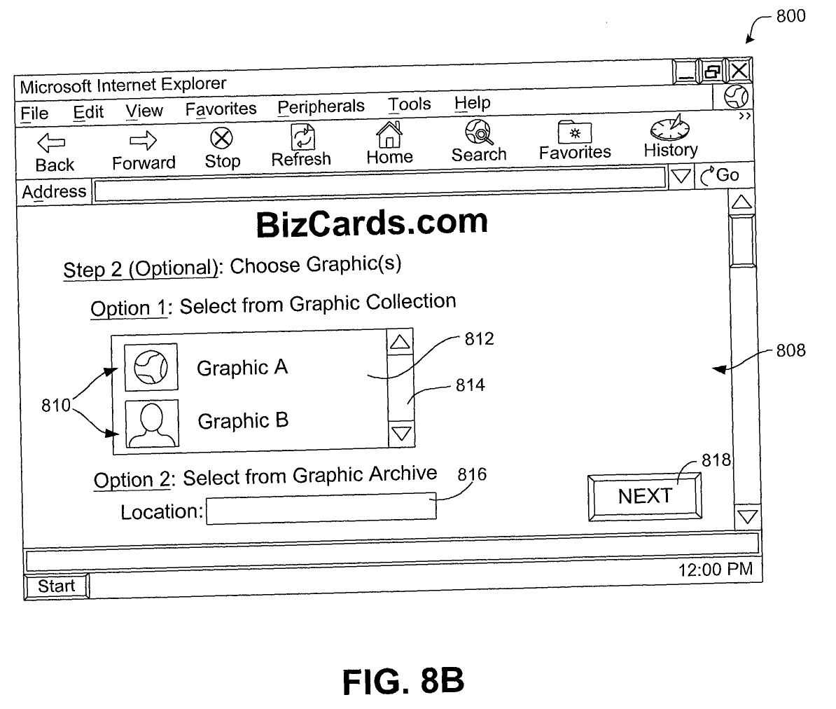

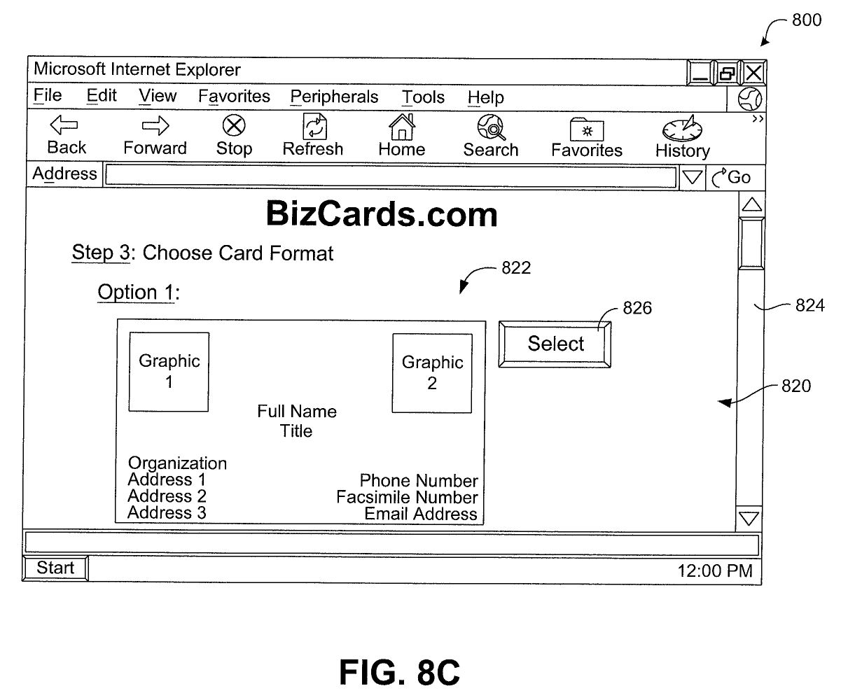

Referring now to FIGS. 7A-7B and 8A-8C, a detailed example of use of the inventive system will be provided. In particular, described is an example of creation of a business card through use of one or a combination of the example systems shown in FIGS. 3 and 4. Beginning with block 700 of FIG. 7A, the user first browses to a business card service with the user browser 304. Typically, this service comprises a web site that is accessed via the Internet. Once the business card service is accessed, the service downloads various content 306 to the user browser 304, as indicated in block 702. As noted above, this content 306 normally includes various text and/or graphics that are displayed to the user to facilitate interfacing between the user and the service. As described above with reference to FIG. 3, this content 306 can, optionally, include generic access instructions 308 that call on methods of an imaging extension 310 of the browser 304 to perform various web imaging operations.

After the business card service has been accessed and the user communicates an interest in producing a business card to the service, the service can prompt the user to provide the various personal information that will be used to create the business card, as indicated in block 704. Typically, this prompting is effected with an interface (e.g., graphical user interface (GUI)) in the form of one or more web pages that are presented to the user with the browser 304. FIG. 8A is a schematic representation of an example browser interface 800 in which an example web page 802 is shown that can be used to prompt the user for his or her personal information. Although the browser interface 800 is shown as a Windows-based browser interface, it will be appreciated that substantially any browser interface could be used. Therefore, the interface may not appear as indicated in FIG. 8A, particularly where the client device 302 comprises a handheld computing device such as a PDA or mobile telephone.

As indicated in FIG. 8A, the page 802 can include various data fields 804 in which the user can enter (e.g., with a keyboard) the various personal information. By way of example, this information can include the user's full name, title, organization, organization address, phone number, facsimile number, email address, and one or more auxiliary pieces of information that the user may wish to include on his or her business card. It is noted that, although the user is described as manually entering this information, one or more pieces of the personal information can be automatically provided to the service where the information is archived in an accessible storage location (e.g., applicable network server). Once the user's personal information has been provided, the user can continue the process by, for instance, selecting a “next” button 806. At this point, various attributes of the personal information text can be selected. For instance, the user can select the type of font(s) to be used, the size of the font(s), etc. These selections can, for example, be entered by the user in a further web page (not shown).

With reference back to FIG. 7A, the user information can be received by the business card service, as indicated in block 706. At this point, the various user information can be stored by the service. As described above with reference to FIGS. 3 and 4, this storage typically comprises storing the information as one or more graphics in the default graphic store 336 of the personal imaging repository 320, as indicated in block 708. In the example system 300 shown in FIG. 3, this is accomplished through use of the imaging extension 310 stored on the user browser 304. In particular, the content 306 downloaded to the browser 304 makes a call (e.g., API call) to the imaging extension 310 to, in turn, cause a call to be made to the user profile store 324 that contains the user profile 326. Through this call, the default graphic store 336 can be accessed and various graphics can be stored therein.

In the example system 400 of FIG. 4, storage of the graphics is accomplished through use of the imaging extension 412. In particular, when the business card service was first accessed, the user's browser 304 can have been redirected by the content 306 downloaded into the browser to an authentication service and the user provided with an opportunity to complete an authentication procedure that identifies both the user's identity and the location of the user's personal imaging repository 320. Once the authentication procedure has been successfully completed, the browser 304 is again redirected and the user information, or at minimum the location of the user profile 326, is supplied to the business card service. With this information, the service can then access the user's personal imaging repository 320 by making a call to the imaging extension 412 to command the imaging extension to make a call to the user profile store 324 of the personal imaging repository 320. It is noted that, although storage of graphics has been described as occurring immediately after the personal information has been received by the business card service, this storage could occur at a later time, for instance after the entire card creation process has been completed. In addition, although use of an imaging extension is specifically identified, persons having ordinary skill in the art will appreciate that, alternatively, the service can directly call the user profile store 324. In such a case, the service can, for instance, use a collection of stubs that are configured to call various elements of the personal imaging repository 320. Continuing on to decision element 710, it can then be determined whether the user wishes to add one or more “graphics” to the business card. As used in this context, graphics refers to images, other than mere text, that the user may wish to provide on the card. For example, the user may wish to add an official logo of his or her organization or a picture of himself or herself. If no such graphics are to be added to the business card, flow continues to block 722 of FIG. 7B. If, on the other hand, one or more such graphics are to be added, flow continues to block 712 at which the user is prompted to select or identify the graphics. Again, this selection or identification typically is facilitated with a user interface that comprises one or more web pages.

An example web page 808 is illustrated in FIG. 8B. As indicated in this figure, the user can be provided with the option of selecting from a collection of graphics provided by the service or from his or her personal imaging repository, or simply identifying the location of a graphic stored in an archive that the user utilizes. In the former case, the user can be provided with a variety of graphics (i.e., images) 810 from which to choose. As shown in FIG. 8B, these graphics can be presented to the user with a window 812, which includes a scroll bar 814 that can be used to scroll through a plurality of different graphics. Where the user wishes to provide his or her own graphic, the user can identify the location of one or more graphics by entering applicable location information in a data field 816 that is presented to the user. By way of example, this location information can comprise an address (e.g., URL) which can be used by the service to retrieve the graphic(s).

Once the various graphics have been selected and/or identified by the user, the user can select a “next” button 818 to transmit the selection and/or identification to the service. This information is then received by the service, as indicated in block 714 of FIG. 7B. Next, it can be determined whether one or more graphics are to be uploaded, as indicated in decision element 716. If not, i.e. the user only selected a graphic from the existing graphic collection of the service or no graphic (i.e., image) is to be added to the business card, flow continues to block 720 described below. If, however, one or more graphics have been identified by the user through the provision of one or more graphic locations, flow continues to block 718 at which the graphic(s) are uploaded. The selected and/or identified graphics can be stored in the default graphic store 336 of the personal imaging repository 320, as indicated in block 720.

Next, the user can be prompted to select the arrangement for the business card, as indicated in block 722. Specifically, the user can identify the placement of each of the stored graphics (i.e., personal information text and any images to be added to the card) of the default graphic store. Once more, this arrangement can be communicated by the user through use of a user interface comprising one or more web pages. FIG. 8C illustrates such a web page 820. As indicated in this figure, the web page 820 can, optionally, comprise one or more default arrangements for the user's selection. By way of example, each arrangement can be visually represented as a mock business card 822. The various different arrangement options can be viewed by the user by, for instance, scrolling through the options using a scroll bar 824 of the browser interface 800. As depicted in FIG. 8C, the various mock business cards provide a what-you-see-is-what-you-get (WYSIWYG) view of the card so that the user can visualize what the finished business card will look like.

Although, as described above, the user can select from various preprogrammed options provided by the business card service, the user can, optionally, manually arrange the various pieces of information and images on a mock business card to personalize the appearance to suit the user's tastes. This can be achieved with a further web page (not shown) which can be accessed with the user's browser 304. In another alternative, the user can designate a default arrangement (i.e., composition) stored in an appropriate storage location (e.g., archive or personal imaging repository 320) with yet another web page (not shown). In any case, the selection can be communicated to the business card service in some manner, for instance by selection of a “select” button 826.

Returning to FIG. 7B, once the arrangement for the business card has been communicated, it is received by the service as indicated in block 724. At this point, the arrangement can be stored by the service, as indicated in block 726. In particular, the arrangement can be stored as a composition in the default composition store 346 of the user's personal imaging repository 320. Once again, this storage can be achieved through use of an imaging extension 310 of the browser 304 or an imaging extension 412 of the business card service. After the arrangement has been stored as a composition, flow for the business card creation is terminated.

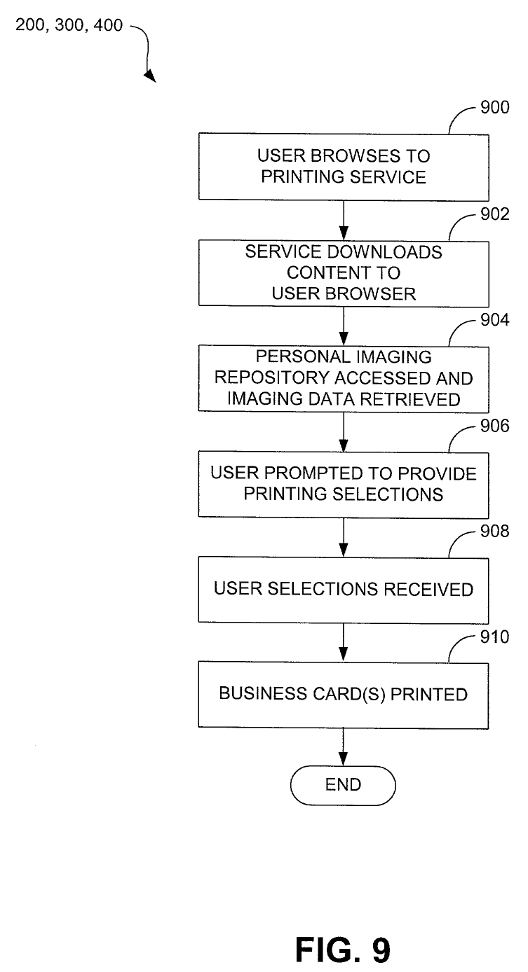

FIG. 9 provides a further example of use of the inventive system. In particular, described is an example of printing a business card using one or a combination of the example systems shown in FIGS. 3 and 4. Beginning with block 900, the user first browses to a printing service which, for example, comprises a web site that is accessed via the Internet. As mentioned above, the user's browser 304 can be directed to the printing service by redirection when the user, for instance, selects a “print” button (not shown) from the business card service web site. Once the printing service is accessed, it downloads content 306 into the user's browser 304, as indicated in block 902. As with the content downloaded from the business card service, this content 306 normally includes various text and/or graphics that are displayed to the user to facilitate interfacing between the user and the service. Where the system is arranged as shown in FIG. 3, the content 306 can also include generic access instructions 308 that call on methods of the imaging extension 310 of the browser 304 so that the user's personal imaging repository 320 can be accessed. Where the system is arranged as shown in FIG. 4, the imaging extension 418 of the printing service is used to access the personal imaging repository 320. In this latter case, the imaging extension 418 knows the location of the personal imaging repository 320 from information provided to the printing service with, for example, a redirection address (e.g., URL).

While the initial printing service web page is being built in the user's browser 304, the printing service simultaneously retrieves the default graphics and default composition residing in the user's default graphic store 336 and default composition store 346, as indicated in block 904. Assuming the user had just created a business card with the business card service, these default graphics and default composition will be those selected with the business card service. These data are presented to the user with the browser 304 once they have been retrieved by the printing service. By way of example, a visual representation of the business card, similar to that shown in FIG. 8C, can be presented to the user as a print preview.

At this point, the user can be prompted to provide various printing selections. For instance, the user can be prompted to select number of business cards to be printed, the type of print media (e.g., paper, cardstock) to be used, the layout of the various business cards on each sheet of the print media, and so forth. Furthermore, where more than one printing device is accessible to the printing service, the user can identify which printing device to be used. Where the printing service operates and maintains its own printing devices, the user may wish to use them for the printing of the business cards. In such a case, the business cards can be printed by the printing service and mailed to the user. Where the user wishes to use a local printing device, for instance one connected to his or her LAN, the user can identify this printing device with an appropriate address (e.g., URL). It is noted, however, that where the user has previously designated a preferred printing device and this designation is stored in the user's personal imaging repository 320 (e.g., as part of the user profile 326), the user need not identify the printing device to be used to complete the print job if the user wishes the preferred printing device to be used.

Once the selections are entered, they are received by the printing service, as indicated in block 908. At this point, the business cards can be printed, as indicated in block 910, and flow for card printing is terminated. Note that, the user can return back to the business card service at any time before the business cards are printed to make changes. For example, if the user sees the print preview of the business card and does not like the personal information, graphic(s), or arrangement of the business card, the user can simply return to the business card service (e.g., by selecting a “back” button of the browser interface 800) and modify the business card.

The above-described examples of operation can be facilitated with various different system configurations. In one such configuration, the imaging service (i.e., business card service) is hosted by an embedded server of a printing device such as a printer. In such an arrangement, the business card service and printing service are provided by the printing device. This arrangement may be advantageous from a printing device marketing standpoint. Where the printing device provides the business card service as well as the printing service, the printing device can be adapted to automatically present the user with the option to create and print business cards when the user selects (e.g., at block 906 in FIG. 9) a type of print media commonly used to print business cards. With such functionality, the user could first visit a web page of the printing service and thereafter create a business card or identify the location of a previously created business card.

In a variation on the printing device-provided business card service theme, the printing device can be configured to present the user with an option of printing business cards when business card print media (e.g., cardstock) is detected by the printing device. In such an arrangement, the printing device is adapted to detect the type of print media fed to or stored in the printing device. Detection can be facilitated by, for example, a bar code reader of the printing device that is adapted to read “invisible” (e.g., infrared) bar codes provided on the print media.

Where the printing device has these detection capabilities but does not host the business card service, the bar code data could include an embedded address (e.g., URL) that identifies the location of an appropriate business card service that can be used. If the user then wishes to create and print business cards, this service could be automatically accessed for the user. In some embodiments, the embedded address can be stored by the printing device for future reference. Furthermore, if desired, the business card service itself can be downloaded into the printing device, assuming the printing device has sufficient capacity to store the service. For instance, if the printing device comprises Java Virtual Machine™ (JVM), the service can be downloaded into the printing device as a Java™ applet. While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for producing a business card, comprising the steps of:
receiving personal information to be provided on the business card;
storing the personal information as at least one graphic in a personal imaging repository;
receiving selection of an arrangement of the personal information on the business card; and
storing the arrangement as a composition in the personal imaging repository;
wherein the personal imaging repository is accessed via an imaging extension.

2. The method of claim 1, wherein the steps of receiving the personal information and receiving the selection of the arrangement comprise receiving the personal information and the arrangement selection with a web site forming part of a business card service.

3. The method of claim 1, wherein the step of storing the personal information comprises storing the personal information as at least one graphic in a default graphic store of the personal imaging repository.

4. The method of claim 1, wherein the step of storing the arrangement comprises storing the arrangement as a composition in a default composition store of the personal imaging repository.

5. The method of claim 1, wherein the personal imaging repository is stored on at least one remote computing device.

6. The method of claim 1, wherein the imaging extension forms part of a browser used to access a business card service that prompts the user for the personal information and the arrangement selection.

7. The method of claim 6, wherein the imaging extension receives calls from generic access instructions downloaded into the browser which request the imaging extension to access the personal imaging repository.

8. The method of claim 1, wherein the imaging extension forms part of a business card service stored on a computing device that prompts the user for the personal information and arrangement selection.

9. The method of claim 8, wherein the imaging extension receives calls from the business card service which request the imaging extension to access the personal imaging repository.

10. The method of claim 1, further comprising the step of receiving selection of at least one graphic to be added to the business card.

11. The method of claim 1, wherein the step of receiving selection of the at least one graphic comprises retrieving the at least one graphic from an archive.

12. The method of claim 1, further comprising the step of presenting a visual representation of the business card to aid a user in selecting an arrangement.

13. The method of claim 1, further comprising the step of accessing and retrieving the stored at least one graphic and composition as default graphics and composition.

14. The method of claim 13, further comprising the step of printing a hard copy of the business card using the default graphics and composition.

15. The method of claim 14, wherein the step of printing is performed by a printing service separate from a business card service that received the personal information and arrangement selection.

16. A distributed system for producing a business card, comprising:
a browser adapted to browse a network;
a business card service accessible over the network;
a printing service accessible over the network;
a personal imaging repository comprising a graphic store configured to store default graphics and a composition store configured to store default compositions; and
an imaging extension that is configured to provide access to the personal imaging repository to the business card service and the printing service.

17. The system of claim 16, wherein the business card service comprises a business card web site.

18. The system of claim 17, wherein the printing service comprises a printing web site.

19. The system of claim 16, wherein the imaging extension comprises part of the browser.

20. The system of claim 19, wherein the browser is configured to receive web content including generic access instructions configured to make calls to the imaging extension.

21. The system of claim 16, wherein the imaging extension comprises part of the business card service.

22. The system of claim 16, wherein the imaging extension comprises part of the printing service.

23. The system of claim 16, further comprising a web server and wherein the business card service and printing service are hosted by the web server.

24. The system of claim 23, further comprising a printing device and wherein the web server is an embedded web server of the printing device.

25. A distributed system for producing a business card, comprising:
a client computing device that executes a web browser which is adapted to receive web content via a network;
a web server that executes a business card service;
a web server that executes a printing service;
a personal imaging repository stored on at least one web server, the personal imaging repository comprising a default graphic store configured to store default graphics and a default composition store configured to store default compositions; and
an imaging extension that forms part of the web browser, the imaging extension configured to receive calls from generic access instructions of content downloaded into the browser that request the imaging extension to access the personal imaging repository.

26. The system of claim 25, wherein the imaging extension comprises application programming instructions.

27. A distributed system for producing a business card, comprising:
a client computing device that executes a web browser which is adapted to receive web content via a network;
a web server that executes a business card service;
a web server that executes a printing service;
a personal imaging repository stored on at least one web server, the personal imaging repository comprising a default graphic store configured to store default graphics and a default composition store configured to store default compositions; and
an imaging extension that forms part of one of the business card service and the printing service, the imaging extension configured to receive calls that request the imaging extension to access the personal imaging repository.

28. The system of claim 27, wherein the imaging extension comprises application programming instructions.
